(19) United States
(12) Patent Application Publication
(10) Pub. No.: US 2018/0315014 A1
(43) Pub. Date: Nov. 1, 2018

(54) DELIVERY SYSTEM

(71) Applicant: KYOCERA Document Solutions Inc., Osaka (JP)

(72) Inventor: Daisuke UTSUMI, Osaka-shi (JP)

(73) Assignee: KYOCERA Document Solutions Inc., Osaka (JP)

(21) Appl. No.: 15/962,352

(22) Filed: Apr. 25, 2018

(30) Foreign Application Priority Data
Apr. 27, 2017 (JP) 2017-088395

(51) Int. Cl. G06Q 10/08; G06K 15/02

(52) U.S. Cl. CPC G06Q 10/0832; G06K 15/02; G06Q 10/0835

(57) ABSTRACT

A delivery system includes an information input device, a data management device, and an image forming apparatus. The information input device receives input of specific information to specify a package recipient and safety information of the package recipient. The data management device is connected to the information input device, communicates data therebetween, and stores the specific information and the safety information inputted to the information input device in association with each other. The image forming apparatus is connected to the data management device and communicates data therebetween. The image forming apparatus includes a control device, a display, and a controller. The control device receives an operation by a package sender. When the control device receives input of the specific information, the controller acquires the safety information associated with the inputted specific information from the data management device. The image forming apparatus displays the acquired safety information on the display.

### INCORPORATION BY REFERENCE

The present application claims priority under 35 U.S.C. § 119 to Japanese Patent Application No. 2017-088395, filed on Apr. 27, 2017. The contents of this application are incorporated herein by reference in their entirety.

### BACKGROUND

The present disclosure relates to a delivery system.

Techniques are proposed to assist in improving delivery service so that delivery of a package from a package sender to a package recipient proceeds without trouble. For example, a delivery system is proposed that notifies a package recipient of information such as scheduled delivery date and time when the delivery of a package is requested.

Incidentally, there are times when residents of a disaster-affected region are evacuated to an evacuation shelter when a natural disaster such as an earthquake or typhoon has occurred. In such a case, the package sender may not know the safety of the package recipient and hesitate to send the package. Alternatively, the package sender requests delivery of the package upon confirming the safety of the package recipient. However, the aforementioned delivery system does not provide safety information of the package recipient to the package sender. Therefore, the package sender needs to confirm the safety of the package recipient using means other than the delivery system. As a result, requesting delivery of the package to the package recipient tends to be burdensome for the package sender.

### SUMMARY

The present disclosure is directed to a delivery system for assisting in delivery of a package to a package recipient. The package is sent at a request of a package sender. The delivery system includes an information input device, a data management device, and an image forming apparatus. The information input device receives input of specific information to specify the package recipient and safety information of the package recipient. The data management device is connected to the information input device and communicates data therebetween. The data management device stores the specific information and the safety information inputted to the information input device in association with each other. The image forming apparatus is connected to the data management device and communicates data therebetween. The image forming apparatus includes a control device, a display, and a controller. The control device receives an operation by the package sender. The display displays a process result according to the operation received by the control device. The controller controls operation of the control device and the display. When the control device receives input of the specific information, the controller acquires the safety information associated with the inputted specific information from the data management device. The controller displays the acquired safety information on the display.

### BRIEF DESCRIPTION OF THE DRAWINGS

FIG. 1 is a diagram illustrating a configuration of a delivery system according to a first embodiment of the present disclosure.

FIG. 2 is a block diagram illustrating the configuration of the delivery system according to the first embodiment of the present disclosure.

FIG. 3 is a diagram illustrating an example of a package recipient table according to the first embodiment of the present disclosure.

FIG. 4 is a diagram illustrating an example of a delivery information table according to the first embodiment of the present disclosure.

FIG. 5 is a diagram illustrating an example of a delivery request table according to the first embodiment of the present disclosure.

FIG. 6 is a diagram illustrating an example of a specific information registration screen according to the first embodiment of the present disclosure.

FIG. 7 is a diagram illustrating an example of a user information retrieval screen according to the first embodiment of the present disclosure.

FIG. 8 is a diagram illustrating an example of a safety information registration screen according to the first embodiment of the present disclosure.

FIG. 9 is a flowchart illustrating a safety information registration process according to the first embodiment of the present disclosure.

FIG. 10A is a diagram illustrating an example of a specific information input screen according to the first embodiment of the present disclosure.

FIG. 10B is a diagram illustrating an example of a safety information display screen according to the first embodiment of the present disclosure.

FIG. 11 is a flowchart illustrating a safety confirmation process according to the first embodiment of the present disclosure.

FIG. 12 is a diagram illustrating an example of a delivery information display screen according to the first embodiment of the present disclosure.

FIG. 13 is a diagram illustrating an example of a delivery request reception screen according to the first embodiment of the present disclosure.

FIG. 14 is a flowchart illustrating a delivery request reception process according to the first embodiment of the present disclosure.

FIG. 15A is a diagram illustrating an example of a delivery slip according to the first embodiment of the present disclosure.

FIG. 15B is a diagram illustrating another example of a delivery slip according to the first embodiment of the present disclosure.

FIG. 16 is a diagram illustrating an example of a delivery information registration screen according to the first embodiment of the present disclosure.

FIG. 17 is a diagram illustrating an example of a delivery request confirmation screen according to the first embodiment of the present disclosure.

FIG. 18 is a diagram illustrating a configuration of a delivery system according to a second embodiment of the present disclosure.

FIG. 19 is a block diagram illustrating the configuration of the delivery system according to the second embodiment of the present disclosure.

### DETAILED DESCRIPTION

Embodiments of a delivery system according to an aspect of the present disclosure will be described as follows with reference to the drawings. It should be noted that elements in the drawings that are the same or equivalent are labelled using the same reference signs and description thereof is not repeated. The drawings are schematic illustrations that emphasize elements of configuration in order to facilitate understanding thereof.

### First Embodiment

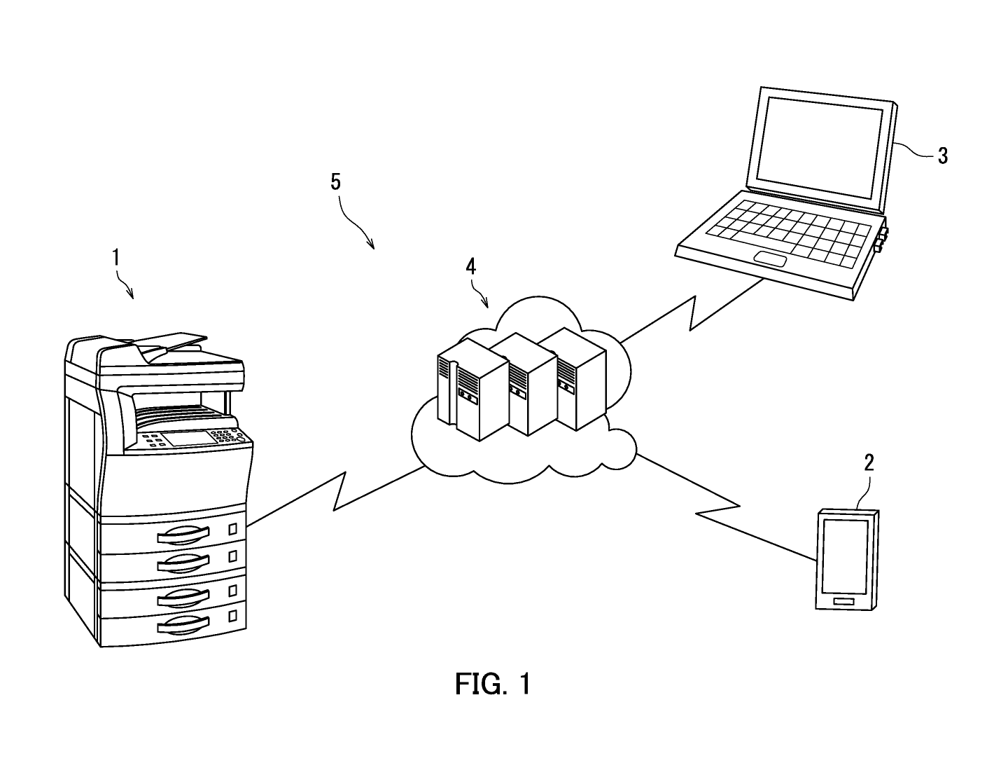

First, a delivery system 5 according to a first embodiment of the present disclosure will be described with reference to FIG. 1. FIG. 1 is a diagram illustrating a configuration of the delivery system 5 according to the first embodiment. The delivery system 5 assists in delivering a package to a package recipient. The package is sent at the request of a package sender. Also, in a case when a disaster occurs that may have affected the package recipient, the delivery system 5 can notify the package sender of safety information of the package recipient when the package sender requests delivery of the package. Whether or not the package recipient may have been affected, for example, is determined depending on whether or not the address of the package recipient is in a disaster-affected region.

As illustrated in FIG. 1, the delivery system 5 includes an image forming apparatus 1, an information input device 2, a delivery company terminal 3, and a data management device 4. According to the present embodiment, the image forming apparatus 1 is located in a store such as a convenience store, for example, and is used by the package sender. The information input device 2 is used by the package recipient in the disaster-affected region. The delivery company terminal 3 is located at an office of a delivery company, for example, and is used by the delivery company. The image forming apparatus 1 is a multifunction peripheral, for example. The information input device 2 is a mobile terminal such as a smartphone, for example. The delivery company terminal 3 is an information processing device such as a personal computer, for example. The data management device 4 is a server, for example.

The image forming apparatus 1 receives a package delivery request from the package sender and generates a delivery slip. The image forming apparatus 1 also notifies the package sender of the safety information of the disaster-affected package recipient.

The information input device 2 receives input of specific information to specify the package recipient. The information input device 2 also receives input of the safety information of the package recipient. According to the present embodiment, the specific information includes information indicating a name of the package recipient (name information) and information indicating an address of the package recipient (address information).

The delivery company terminal 3 receives input of delivery information. The delivery company terminal 3 also provides the delivery company with information related to the package delivery request (delivery request information).

The data management device 4 stores the specific information and the safety information of the package recipient inputted to the information input device 2 in association with each other.

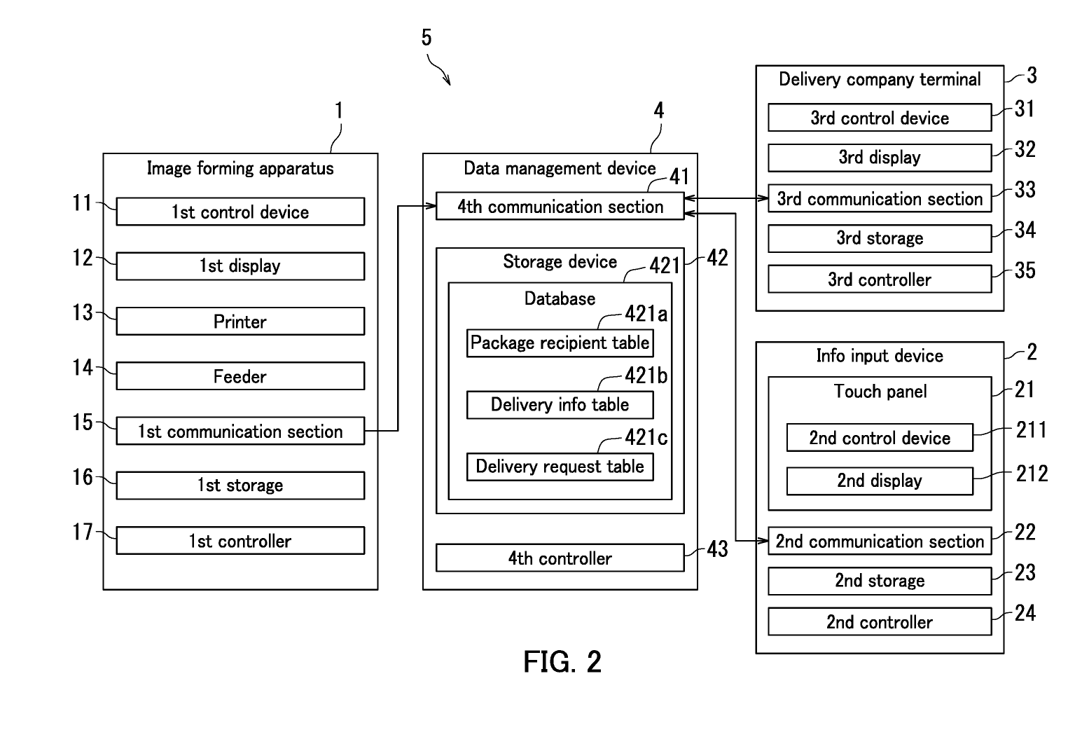

Continuing, a configuration of the delivery system 5 according to the first embodiment will be further described with reference to FIG. 2. FIG. 2 is a block diagram illustrating the configuration of the delivery system 5 according to the first embodiment.

As illustrated in FIG. 2, the image forming apparatus 1 includes a first control device 11, a first display 12, a printer 13, a feeder 14, a first communication section 15, first storage 16, and a first controller 17. The first control device 11 includes a plurality of operation keys. The operation keys include character input keys, a numeric keypad, and a start key, for example. The package sender can input instructions to the image forming apparatus 1 by operating the operation keys. The first control device 11 generates a signal indicating an instruction from the package sender when receiving the instruction, and sends the signal to the first controller 17.

According to the present embodiment, the package sender can instruct the image forming apparatus 1 to execute a safety confirmation process, a delivery request reception process, and a delivery information display process by operating the first control device 11. The first control device 11 sends a signal indicating an execution instruction of the safety confirmation process, the delivery request reception process, or the delivery information display process to the first controller 17 when the execution instruction of the safety confirmation process, the delivery request reception process, or the delivery information display process is inputted.

The first display 12 includes a liquid-crystal display, for example. The first display 12 displays information such as a result of a process performed by the first controller 17. According to the present embodiment, the first display 12 displays a selection screen of processes for the image forming apparatus 1 to execute. In detail, the first display 12 displays a selection screen through which execution of any of the following processes can be selected: the safety confirmation process, the delivery request reception process, and the delivery information display process.

The printer 13 forms images on sheets. The printer 13 includes an exposure device, a photosensitive drum, a developing device, and a transfer device. The exposure device irradiates the photosensitive drum to form an electrostatic latent image. The developing device supplies toner to the photosensitive drum to develop the electrostatic latent image. The transfer device transfers a toner image formed on the photosensitive drum to a sheet.

The feeder 14 feeds the sheets one at a time to the printer 13. The feeder 14 includes a plurality of cassettes. Each cassette is able to house a plurality of the sheets. According to the present embodiment, each cassette houses sheets of a size varying according to the cassette.

The first communication section 15 connects to the data management device 4 and communicates data therebetween. The first communication section 15 connects to the data management device 4 through a network such as the Internet. The first communication section 15 is a network interface such as a local area network (LAN) adapter.

The first storage 16 includes a storage medium such as a hard-disk drive (HDD), random-access memory (RAM), or read-only memory (ROM). The first storage 16 stores a control program for controlling operation of each section of the image forming apparatus 1. The control program is executed by the first controller 17.

The first controller 17 includes components such as a central processing unit (CPU) or an application-specific integrated circuit (ASIC). The first controller 17 controls the operation of each section of the image forming apparatus 1. According to the present embodiment, the first controller 17 executes the safety confirmation process when receiving a signal indicating the execution instruction of the safety confirmation process. The first controller 17 executes the delivery request reception process when receiving a signal indicating the execution instruction of the delivery request reception process. The first controller 17 executes the delivery information display process when receiving a signal indicating the execution instruction of the delivery information display process.

Next, a configuration of the information input device 2 will be described. The information input device 2 includes a touch panel 21, a second communication section 22, second storage 23, and a second controller 24. The second controller 24 is an example of an input controller.

The touch panel 21 includes a second control device 211 and a second display 212. The second control device 211 includes a resistive touch sensor, for example. The second display 212 includes a liquid-crystal display, for example. According to the present embodiment, the package recipient can instruct the information input device 2 to execute a specific information registration process and a safety information registration process by operating the touch panel 21.

The second control device 211 includes a touch screen. The second control device 211 generates a signal indicating a pressed location when detecting a press on the touch screen. The signal indicating the pressed location is sent to the second controller 24.

The second display 212 includes a display surface. The display surface is located beneath the touch surface of the second control device 211. The second display 212 displays information such as a result of a process performed by the second controller 24 on the display surface. The second display 212 displays various buttons including character input buttons. The second controller 24 determines a button corresponding to the location indicated by the signal received from the second control device 211. As such, the second controller 24 executes a process corresponding to the pressed button. According to the present embodiment, the second display 212 displays, on the display surface, a selection screen of processes for the information input device 2 to execute. In detail, the second display 212 displays a selection screen through which execution of either the specific information registration process or the safety information registration process can be selected.

The second communication section 22 is connected to the data management device 4 and communicates data therebetween. According to the present embodiment, the second communication section 22 connects to the data management device 4 through a network such as the Internet. The second communication section 22 is a network interface such as a LAN adapter, for example.

The second storage 23 includes a storage medium such as an HDD, RAM, or ROM. The second storage 23 stores a control program for controlling operation of each section of the information input device 2. The control program is executed by the second controller 24.

The second controller 24 includes components such as a CPU. The second controller 24 controls the operation of each section of the information input device 2. According to the present embodiment, the second controller 24 executes the specific information registration process when determining that the button instructing execution of the specific information registration process has been pressed. The second controller 24 executes the safety information registration process when determining that the button instructing execution of the safety information registration process has been pressed.

Next, a configuration of the delivery company terminal 3 will be described. The delivery company terminal 3 includes a third control device 31, a third display 32, a third communication section 33, third storage 34, and a third controller 35.

The third control device 31 includes a keyboard, for example. The delivery company can input instructions to the delivery company terminal 3 by operating the keyboard. The third control device 31 generates a signal indicating an instruction from the delivery company when the instruction is received, and sends the instruction to the third controller 35. According to the present embodiment, the delivery company can instruct the delivery company terminal 3 to execute a delivery information registration process and a delivery request confirmation process by operating the third control device 31. The third control device 31 sends a signal indicating an execution instruction of the delivery information registration process or the delivery request confirmation process to the third controller 35 when the execution instruction of the delivery information registration process or the delivery request confirmation process is inputted.

The third display 32 includes a liquid-crystal display, for example. The third display 32 displays information such as a result of a process performed by the third controller 35. According to the present embodiment, the third display 32 displays a selection screen of processes for the delivery company terminal 3 to execute. In detail, the third display 32 displays a selection screen through which execution of either the delivery information registration process or the delivery request confirmation process can be selected.

The third communication section 33 connects to the data management device 4 and communicates data therebetween. According to the present embodiment, the third communication section 33 connects to the data management device 4 through a network such as the Internet. The third communication section 33 is a network interface such as a LAN adapter.

The third storage 34 includes a storage medium such as an HDD, RAM, or ROM. The third storage 34 stores a control program for controlling operation of each section of the delivery company terminal 3. The control program is executed by the third controller 35.

The third controller 35 includes components such as a CPU. The third controller 35 controls the operation of each section of the delivery company terminal 3. According to the present embodiment, the third controller 35 executes the delivery information registration process when receiving a signal indicating an execution instruction of the delivery information registration process. The third controller 35 executes the delivery request confirmation process when receiving a signal indicating an execution instruction of the delivery request confirmation process.

Continuing, a configuration of the data management device 4 will be described. The data management device 4 includes a fourth communication section 41, a storage device 42, and a fourth controller 43.

The fourth communication section 41 connects to the first communication section 15, the second communication section 22, and the third communication section 33 and communicates data therebetween. The fourth communication section 41 is a network interface that communicates with the first communication section 15, the second communication section 22, and the third communication section 33 using the same communication method. According to the present embodiment, the fourth communication section 41 connects to the first communication section 15, the second communication section 22, and the third communication section 33 through a network such as the Internet. The fourth communication section 41 is a LAN adapter, for example.

The storage device 42 includes a storage medium such as either or both of an HDD and a solid-state drive (SSD). The storage device 42 may also include a storage medium such as RAM or ROM. The storage device 42 stores a control program for controlling operation of each section of the data management device 4. The control program is executed by the fourth controller 43. The storage device 42 also includes a database 421. According to the present embodiment, the database 421 includes a package recipient table 421a, a delivery information table 421b, and a delivery request table 421c.

The fourth controller 43 includes components such as a CPU. The fourth controller 43 controls the operation of each section of the data management device 4.

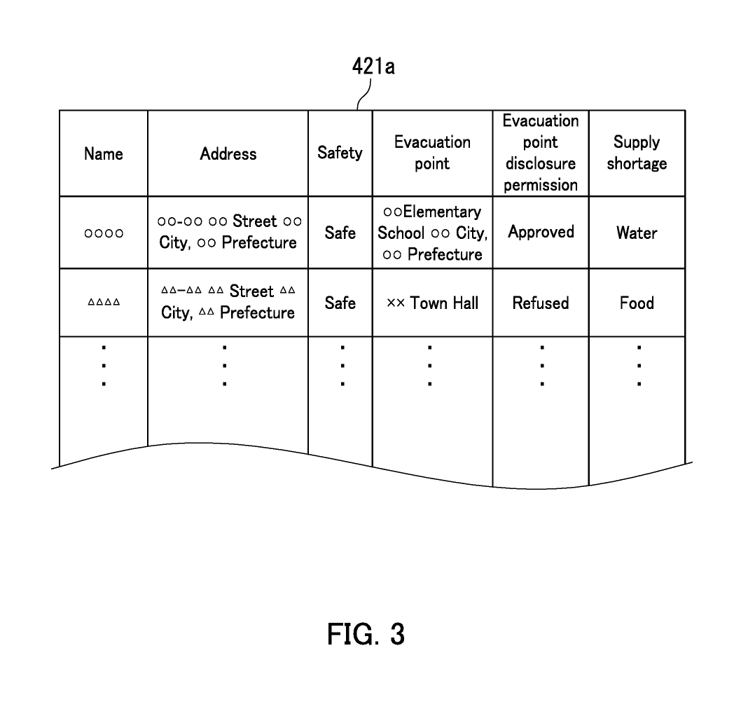

Continuing, the package recipient table 421a, the delivery information table 421b, and the delivery request table 421c will be described with reference to FIGS. 3 to 5.

FIG. 3 is a diagram illustrating an example of the package recipient table 421a. As illustrated in FIG. 3, the package recipient table 421a stores user information of the package recipient. The user information includes specific information and safety information of the package recipient. The specific information includes name information and address information of the package recipient. The user information further includes information indicating an evacuation point of the package recipient (evacuation point information), information indicating disclosure permission for the evacuation point (evacuation point disclosure permission information), and information indicating a supply shortage (supply shortage information). The safety information is deleted by the fourth controller 43 when a predetermined period since a last safety information update passes, for example. The predetermined period is three months, for example. Therefore, a storage area of the storage device 42 can be used effectively. Alternatively, the safety information is deleted according to an instruction from a person such as the package recipient through the information input device 2.

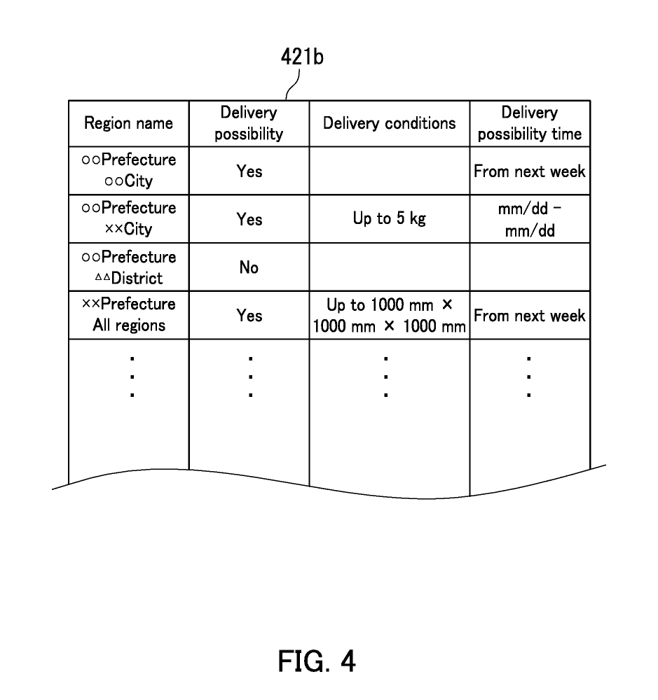

FIG. 4 is a diagram illustrating an example of the delivery information table 421b. As illustrated in FIG. 4, the delivery information table 421b stores delivery information related to whether or not a package can be delivered to the disaster-affected region. The delivery information includes information indicating a region name (region name information), information indicating delivery possibility (delivery possibility information), information indicating delivery conditions (delivery condition information), and information indicating a time in which delivery is possible (delivery possibility time information). Note that in the example illustrated in FIG. 4, a blank item under “delivery conditions” indicates that there are no delivery conditions.

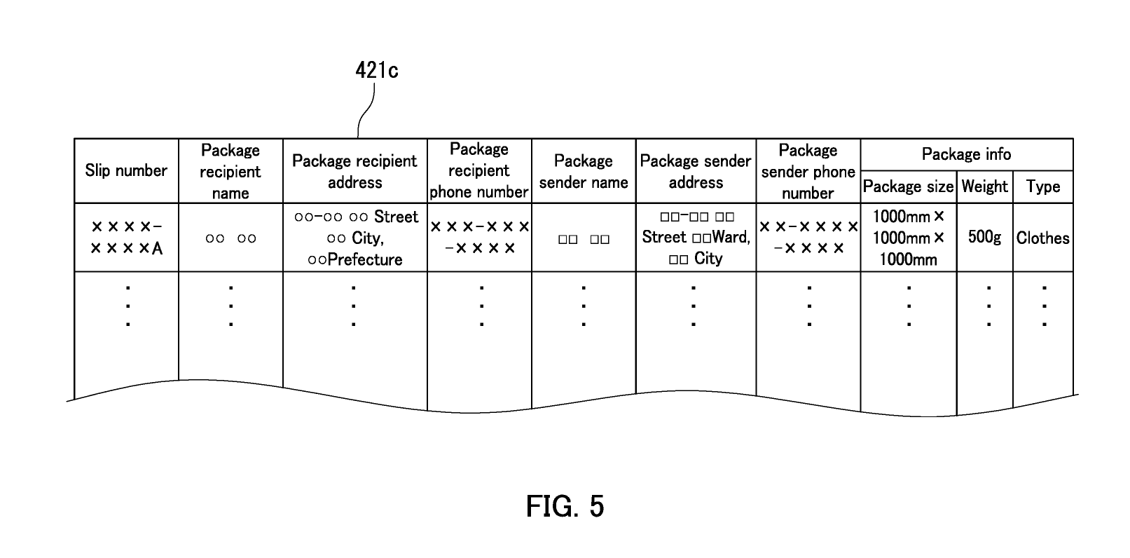

FIG. 5 is a diagram illustrating an example of the delivery request table 421c. As illustrated in FIG. 5, the delivery request table 421c stores delivery request information received by the delivery system 5. The delivery request information includes information indicating a slip number, name information of the package recipient, address information of the package recipient, information indicating a telephone number of the package recipient (telephone number information), name information of the package sender, address information of the package sender, information indicating the telephone number of the package sender (telephone number information), and information related to the package (package information). The slip number is a sequence number assigned to each delivery request. According to the present embodiment, the package information includes information indicating a size of the package, information indicating a weight of the package, and information indicating a type of the package.

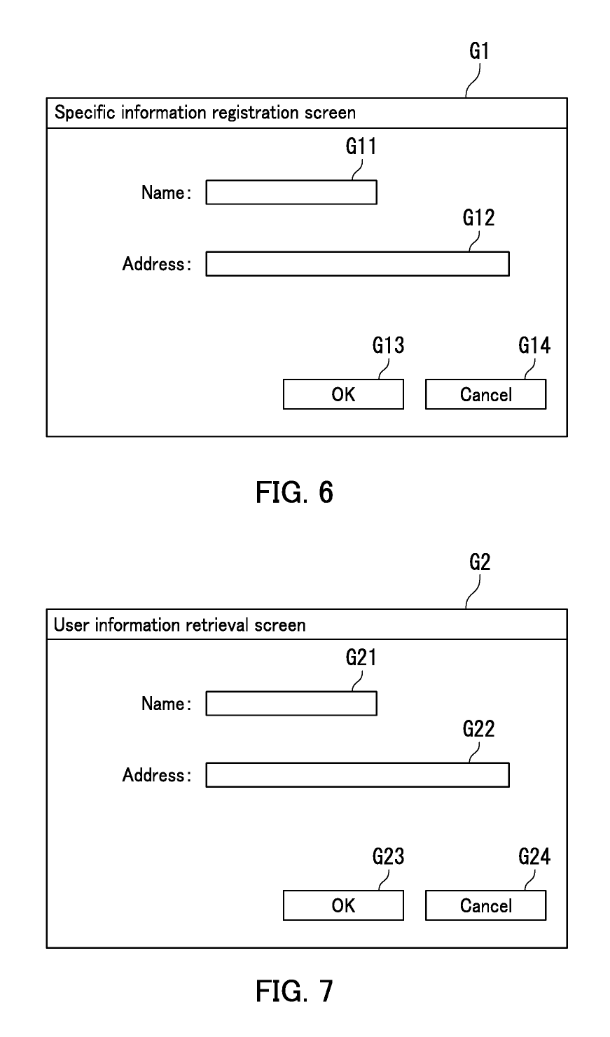

Next, the specific information registration process will be described with reference to FIGS. 2, 3, and 6. The specific information registration process is executed by the information input device 2. FIG. 6 is a diagram illustrating an example of a specific information registration screen G1. The specific information registration screen G1 is displayed on the touch panel 21 when the specific information registration process is started.

As illustrated in FIG. 6, the specific information registration screen G1 includes a name information input field G11, an address information input field G12, an OK button G13, and a cancel button G14.

The name information input field G11 receives input of the name information of the package recipient. The address information input field G12 receives input of the address information of the package recipient. When the OK button G13 is pressed, the name information inputted to the name information input field G11 and the address information inputted to the address information input field G12 are registered (stored) in the package recipient table 421a, and the specific information registration process ends. Note that the specific information registration process also ends when the cancel button G14 is pressed.

Next, the safety information registration process will be described with reference to FIGS. 2, 3, and 7 to 9. The safety information registration process is executed by the information input device 2. Note that in the example illustrated in FIGS. 7 to 9, the specific information of the package recipient is registered to the package recipient table 421a before the safety information is registered.

FIG. 7 is a diagram illustrating an example of a user information retrieval screen G2. The user information retrieval screen G2 is displayed on the touch panel 21 when the safety information registration process is started.

As illustrated in FIG. 7, the user information retrieval screen G2 receives input of the specific information (name information and address information). In detail, the user information retrieval screen G2 includes a name information input field G21, an address information input field G22, an OK button G23, and a cancel button G24.

The name information input field G21 receives input of the name information. The address information input field G22 receives input of the address information. When the OK button G23 is pressed, the second controller 24 acquires, from the package recipient table 421a, the user information of the package recipient matching the name information inputted to the name information input field G21 and the address information inputted to the address information input field G22. Note that the safety information registration process ends when the cancel button G24 is pressed.

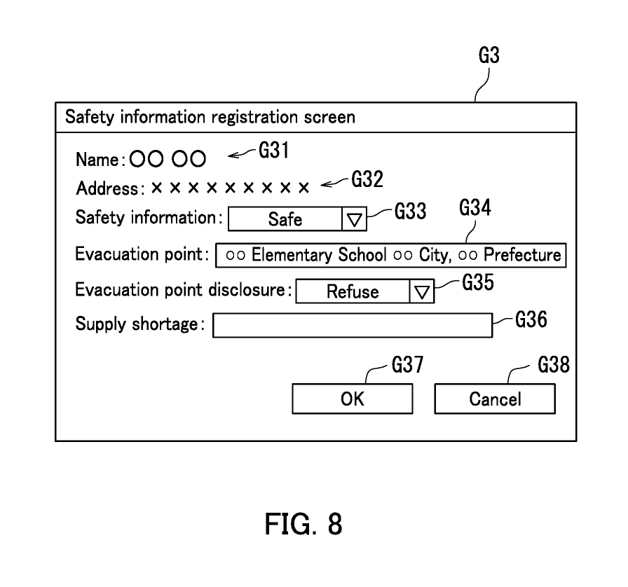

FIG. 8 is a diagram illustrating an example of a safety information registration screen G3. The safety information registration screen G3 is displayed on the touch panel 21 when the second controller 24 acquires the user information from the package recipient table 421a through the user information retrieval screen G2.

As illustrated in FIG. 8, the safety information registration screen G3 includes a name information display field G31, an address information display field G32, a safety information input field G33, an evacuation point information input field G34, an evacuation point disclosure permission information input field G35, a supply shortage information input field G36, an OK button G37, and a cancel button G38.

The name information display field G31 displays the name information acquired from the package recipient table 421a. The address information display field G32 displays the address information acquired from the package recipient table 421a. The safety information input field G33 receives input of the safety information. The evacuation point information input field G34 receives input of the evacuation point information of the package recipient. The evacuation point disclosure permission information input field (335 receives input of whether to disclose (disclosure approval) or not to disclose (disclosure refusal) the evacuation point information. The supply shortage information input field G36 receives input of supply shortage information.

When the OK button G37 is pressed, the safety information inputted to the safety information input field G33, the evacuation point information inputted to the evacuation point information input field G34, the evacuation point disclosure permission information inputted to the evacuation point disclosure permission information input field G35, and the supply shortage information inputted to the supply shortage information input field G36 are added (registered) to the package recipient table 421a. As a result, the user information is updated and the safety information registration process ends. Note that the safety information registration process also ends when the cancel button G38 is pressed.

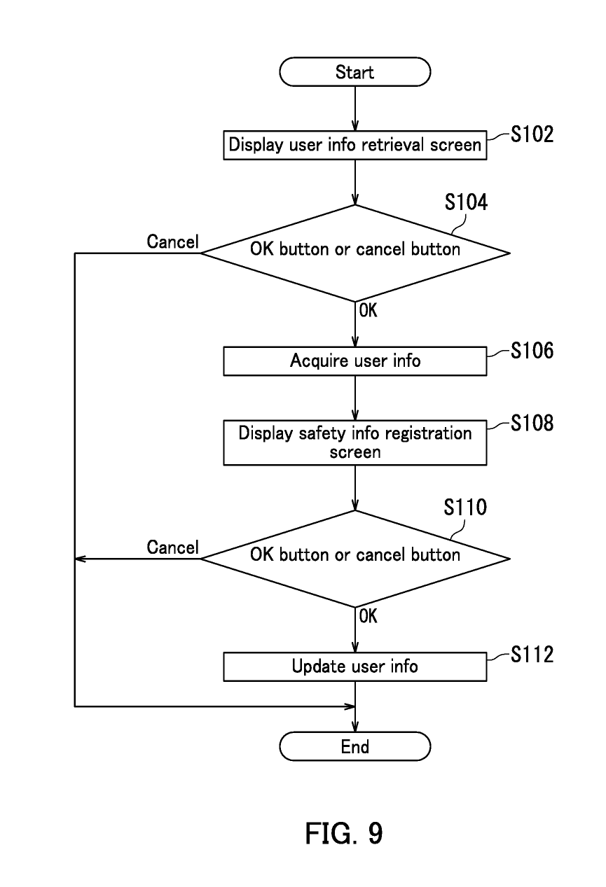

FIG. 9 is a flowchart illustrating the safety information registration process. The safety information registration process is started when a signal indicating an execution instruction of the safety information registration process is inputted to the second controller 24.

As illustrated in FIG. 9, the second controller 24 displays the user information retrieval screen G2 on the touch panel 21 (Step S102). Next, the second controller 24 determines whether either the OK button G23 or the cancel button G24 in the user information retrieval screen G2 has been pressed (Step S104). When the second controller 24 determines that the OK button G23 has been pressed (Step S104: OK), the second controller 24 acquires, from the package recipient table 421a, the user information matching the name information and the address information inputted to the user information retrieval screen G2 (Step S106). Next, the second controller 24 displays the safety information registration screen G3 on the touch panel 21 (Step S108). The second controller 24 determines whether either the OK button G37 or the cancel button G38 in the safety information registration screen G3 has been pressed (Step S110). When the second controller 24 determines that the OK button G37 has been pressed (Step S110: OK), the second controller 24 updates the user information (Step S112). When the user information is updated, the safety information registration process ends.

The second controller 24 does not update the user information when the second controller 24 determines that the cancel button G24 in the user information retrieval screen G2 has been pressed (Step S104: Cancel), or that the cancel button G38 in the safety information registration screen G3 has been pressed (Step S110: Cancel). Thus, the safety information registration process ends.

Next, the safety confirmation process will be described with reference to FIGS. 2, 3, 10A, 10B, and 11. The safety confirmation process is executed by the image forming apparatus 1.

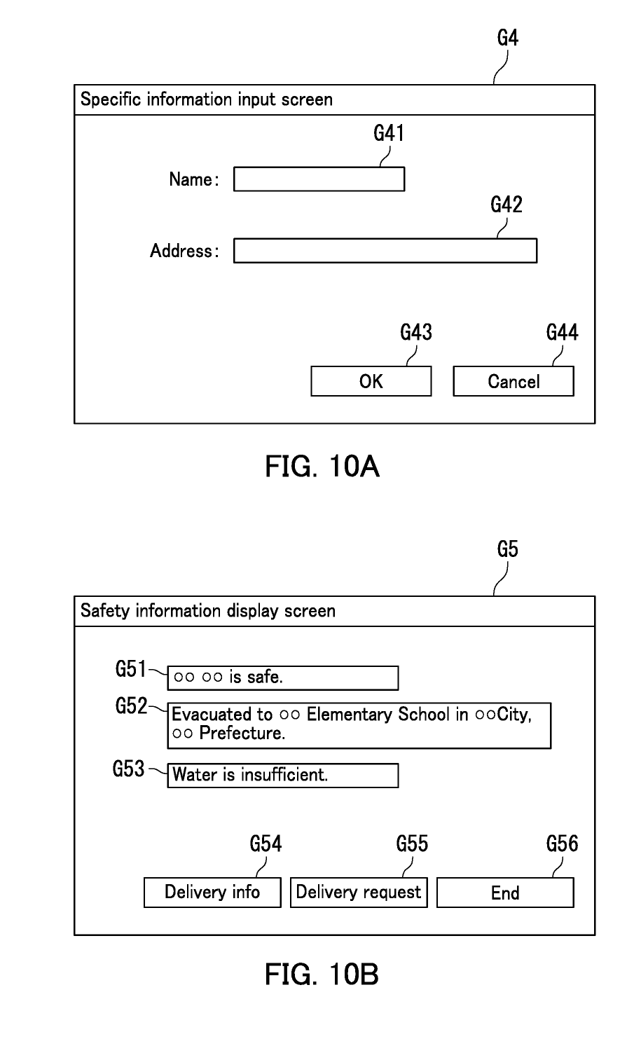

FIG. 10A is a diagram illustrating an example of a specific information input screen G4. The specific information input screen G4 is displayed on the first display 12 when the safety confirmation process is started.

As illustrated in FIG. 10A, the specific information input screen G4 includes a name information input field G41, an address information input field G42, an OK button G43, and a cancel button G44.

The name information input field G41 receives input of the name information. The address information input field G42 receives input of the address information. When the OK button G43 is pressed, the first controller 17 acquires, from the package recipient table 421a, the user information of the package recipient (hereafter also referred to as a specific user) matching the name information and the address information respectively inputted to the name information input field G41 and the address information input field G42. Note that the safety confirmation process ends when the cancel button G44 is pressed.

FIG. 10B is a diagram illustrating an example of a safety information display screen G5. The safety information display screen G5 is displayed on the first display 12 when the first controller 17 acquires the user information of the specific user from the package recipient table 421a through the specific information input screen G4.

As illustrated in FIG. 10B, the safety information display screen G5 is displayed based on information acquired from the package recipient table 421a. In detail, the safety information display screen G5 includes a safety information display field G51, an evacuation point information display field G52, a supply shortage information display field G53, a delivery information button G54, a delivery request button G55, and an end button G56. The safety information display field G51 displays the name information and the safety information of the specific user. The evacuation point information display field G52 displays the evacuation point information of the specific user. The supply shortage information display field G53 displays the supply shortage information of the specific user. Note that the evacuation point information is not displayed when the evacuation point disclosure permission information of the specific user indicates disclosure refusal.

When the delivery information button G54 is pressed, the first controller 17 executes the delivery information display process. When the delivery request button G55 is pressed, the first controller 17 executes the delivery request reception process. When the end button G56 is pressed, the first controller 17 ends the safety confirmation process.

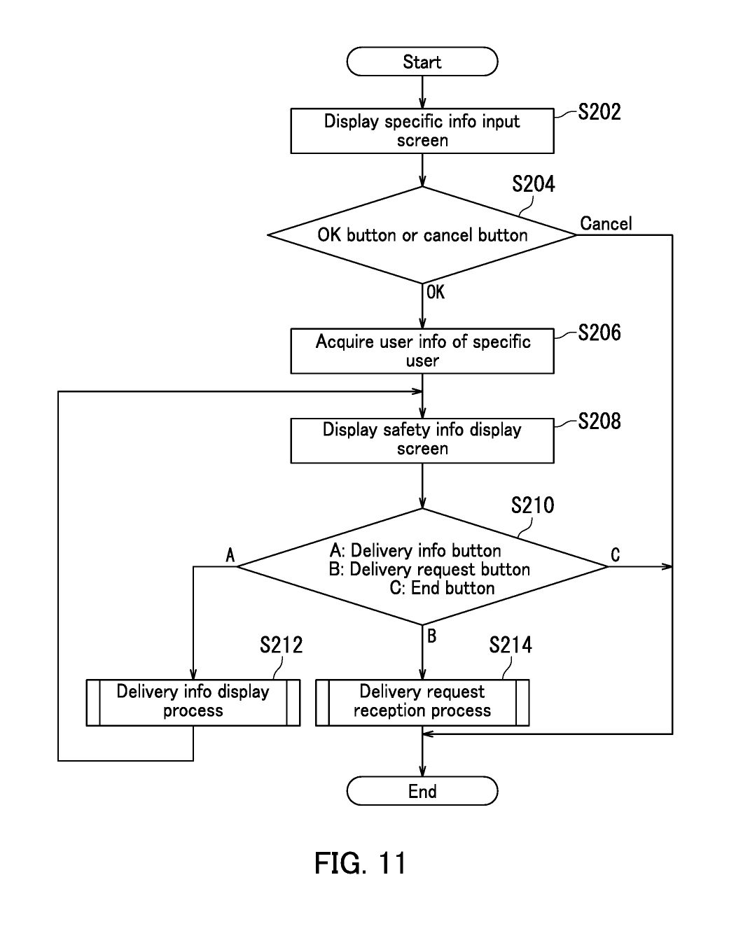

FIG. 11 is a flowchart illustrating the safety confirmation process. As illustrated in FIG. 11, the first controller 17 displays the specific information input screen G4 on the first display 12 when the safety confirmation process begins (Step S202). The first controller 17 determines whether either the OK button G43 or the cancel button G44 in the specific information input screen G4 has been pressed (Step S204). When the first controller 17 determines that the OK button G43 has been pressed (Step S204: OK), the first controller 17 acquires the user information of the specific user from the package recipient table 421a (Step S206), and displays the safety information display screen G5 on the first display 12 (Step S208). When the first controller 17 determines that the cancel button G44 in the specific information input screen G4 has been pressed by contrast (Step S204: Cancel), the first controller 17 ends the safety confirmation process.

The first controller 17 determines whether any of the following buttons in the safety information display screen G5 have been pressed: the delivery information button G54, the delivery request button G55, or the end button G56 (Step S210). When the first controller 17 determines that the delivery information button G54 has been pressed (Step S210: A), the first controller 17 executes the delivery information display process (Step S212). Also, when the first controller 17 determines that the delivery request button G55 has been pressed (Step S210: B), the first controller 17 executes the delivery request reception process (Step S214). When the first controller 17 determines that the end button G56 has been pressed (Step S210: C), the first controller 17 ends the safety confirmation process. Note that when the first controller 17 ends the delivery information display process (Step S212), the first controller 17 displays the safety information display screen G5 on the first display 12 (Step S208). The first controller 17 also ends the safety confirmation process when ending the delivery request reception process (Step S214).

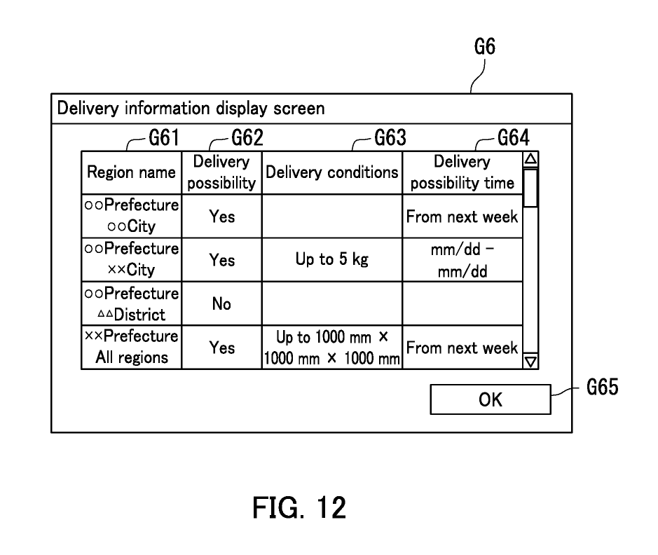

Next, the delivery information display process will be described with reference to FIGS. 2, 4, 10B, and 12. FIG. 12 is a diagram illustrating an example of a delivery information display screen G6. The delivery information display screen G6 is displayed when the first controller 17 acquires the delivery information from the delivery information table 421b. The delivery information is acquired from the delivery information table 421b when the delivery information button G54 described with reference to FIG. 10B is pressed to start the delivery information display process.

As illustrated in FIG. 12, the delivery information display screen G6 displays the delivery information acquired from the delivery information table 421b. In detail, the delivery information display screen G6 includes a region name information display field G61, a delivery possibility information display field G62, a delivery condition information display field G63, a delivery possibility time information display field G64, and an OK button G65. Each of the display fields G61 to G64 displays information acquired from a corresponding item of the delivery information table 421b.

The delivery information display process ends when the OK button G65 is pressed. When the delivery information display process ends, the delivery information display screen G6 is closed and the safety information display screen G5 is displayed on the first display 12.

Next, the delivery request reception process will be described with reference to FIGS. 2, 5, 13, and 14. The delivery request reception process is started when the delivery request button G55 is pressed in the safety information display screen G5 illustrated in FIG. 10B.

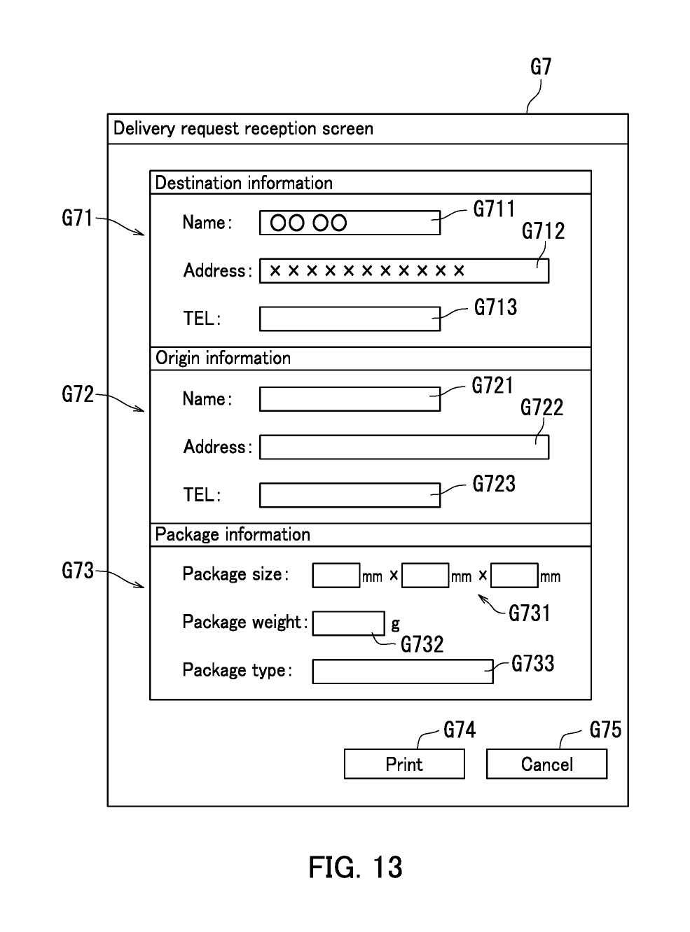

FIG. 13 is a diagram illustrating an example of a delivery request reception screen G7. The delivery request reception screen G7 is displayed on the first display 12 when the delivery request reception process is started.

As illustrated in FIG. 13, the delivery request reception screen G7 includes a destination information input field G71, an origin information input field G72, a package information input field G73, a print button G74, and a cancel button G75.

The destination information input field G71 includes a package recipient name information input field G711, a package recipient address information input field G712, and a package recipient telephone number information input field G713. The package recipient name information input field G711 receives input of the name information of the package recipient. The package recipient address information input field G712 receives input of the address information of the package recipient. The package recipient telephone number information input field G713 receives input of the telephone number information of the package recipient. Note that the package recipient name information input field G711 and the package recipient address information input field G712 may respectively display the name information and the address information inputted to the specific information input screen G4 described with reference to FIG. 10A.

The origin information input field G72 includes a package sender name information input field G721, a package sender address information input field G722, and a package sender telephone number information input field G723. The package sender name information input field G721 receives input of the name information of the package sender. The package sender address information input field G722 receives input of the address information of the package sender. The package sender telephone number information input field G723 receives input of the telephone number information of the package sender.

The package information input field G73 receives input of the package information. The package information input field G73 includes a package size information input field G731, a package weight information input field G732, and a package type information input field G733. The package size information input field G731 receives input of information indicating the package size. The package weight information input field G732 receives input of information indicating the package weight. The package type information input field G733 receives input of information indicating the package type. The package type includes clothing and food, for example.

When the print button G74 is pressed, the first controller 17 stores the destination information, origin information, and package information respectively inputted to the destination information input field G71, the origin information input field G72, and the package information input field G73 in the delivery request table 421c. The first controller 17 also executes a delivery slip generation process. According to the present embodiment, the feeder 14 feeds a delivery slip sheet from a cassette housing delivery slip sheets when a delivery slip is generated. An image exhibiting a layout of the delivery slip is formed in advance on the delivery slip sheet. The printer 13 prints images exhibiting the destination information, the origin information, and the package information on the delivery slip sheet. As a result, the delivery request reception process ends. Note that when the delivery request reception process ends, the safety confirmation process also ends. The delivery request reception process and the safety confirmation process also end when the cancel button G75 is pressed.

According to the present embodiment, the feeder 14 houses differently sized delivery slip sheets in different cassettes. The first controller 17 determines the sheet to be fed according to whether or not the user information of the specific user includes the evacuation point information. For example, when the user information of the specific user includes evacuation point information, the delivery slip sheet to be fed is of a different size than the delivery slip sheet to be fed when the user information does not include the evacuation point information. Therefore, the delivery company can be notified that the package needs to be delivered to the evacuation point. Note that the printer 13 may form a notification image on the delivery slip sheet in addition to images exhibiting the destination information, the origin information, and the package information. The notification image includes an image to notify the delivery company that the package must be delivered to the evacuation point. The notification image exhibits a message or a character to notify that the delivery must be to the evacuation point, for example. When the notification image is printed, the delivery slip sheet to be fed may be of the same size as the delivery slip sheet to be fed when the user information of the specific user does not include the evacuation point information.

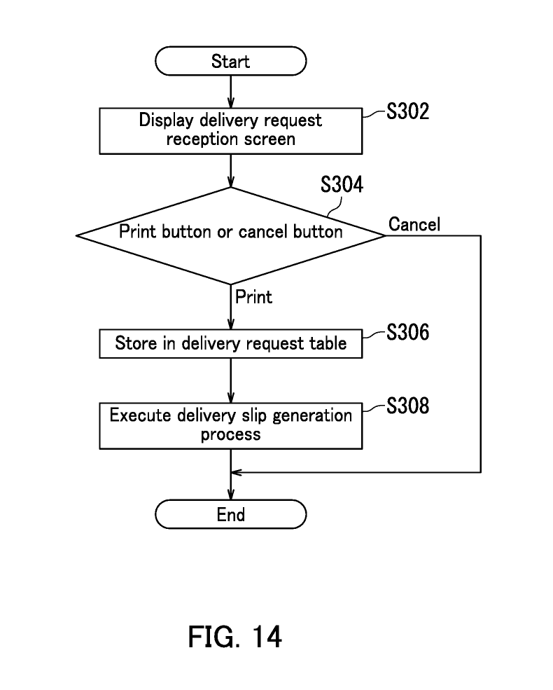

FIG. 14 is a flowchart illustrating the delivery request reception process. As illustrated in FIG. 14, the first controller 17 displays the delivery request reception screen G7 on the first display 12 (Step S302). The first controller 17 determines whether either the print button G74 or the cancel button G75 in the delivery request reception screen G7 has been pressed (Step S304). When the first controller 17 determines that the print button G74 has been pressed (Step S304: Print), the first controller 17 registers (stores) the destination information, the origin information, and the package information in the delivery request table 421c (Step S306). At this time, the slip number is registered in the delivery request table 421c. Continuing, the first controller 17 executes the delivery slip generation process (Step S308) and ends the delivery request reception process. When the first controller 17 determines that the cancel button G75 has been pressed by contrast (Step S304: Cancel), the first controller 17 does not execute the delivery slip generation process and ends the delivery request reception process. Note that the order of Step S306 and Step S308 is interchangeable.

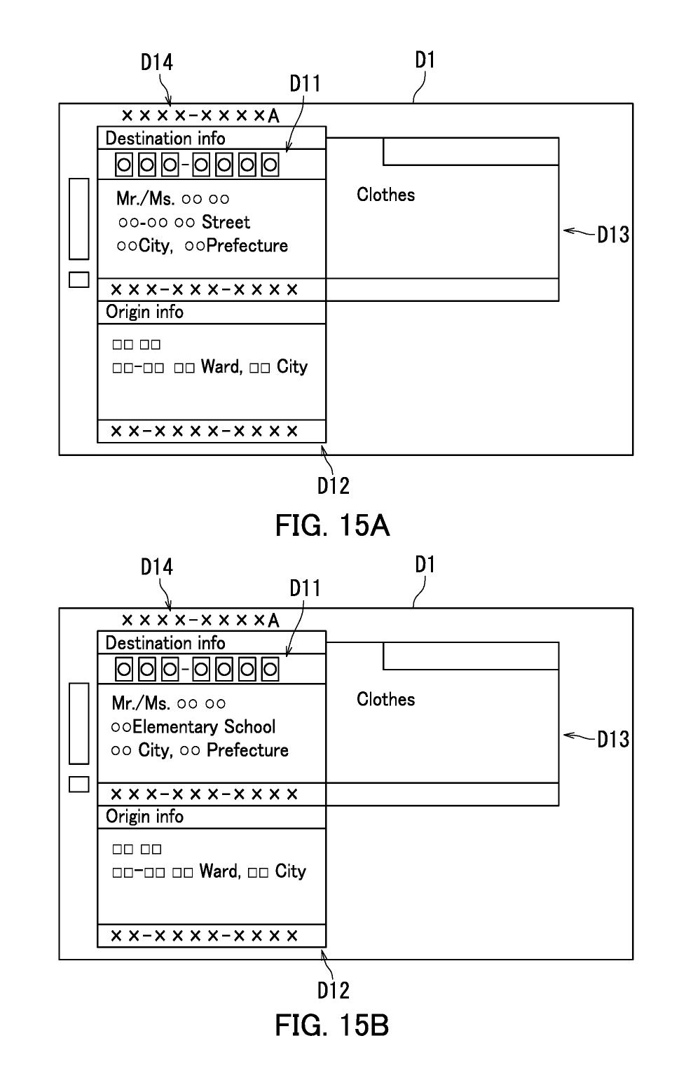

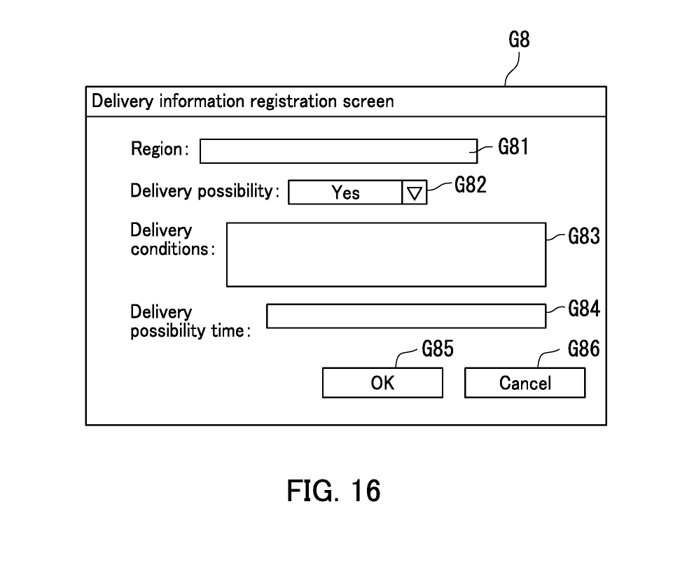

Continuing, a delivery slip D1 according to the first embodiment will be described with reference to FIGS. 2, 13, 15A, and 15B. FIG. 15A is a diagram illustrating an example of the delivery slip D1 according to the first embodiment. In detail, FIG. 15A illustrates the delivery slip D1 generated when the user information of the specific user does not contain the evacuation point information, or the user information of the specific user contains the evacuation point information but the evacuation point disclosure permission information indicates disclosure refusal.

As illustrated in FIG. 15A, the information inputted to each of the input fields G71 to G73 of the delivery request reception screen G7 described with reference to FIG. 13 is printed on the delivery slip D1. In detail, the delivery slip D1 includes a destination information print field D11, an origin information print field D12, a package information print field D13, and a slip number print field D14. An image exhibiting the destination information (the name information, the address information, and the telephone number information of the package recipient) inputted to the destination information input field G71 is printed in the destination information print field D11. An image exhibiting the origin information inputted to the origin information input field G72 is printed in the origin information print field D12. An image exhibiting the package information inputted to the package information input field G73 is printed in the package information print field D13. An image exhibiting the slip number assigned when the destination information, the origin information, and the package information were registered to the delivery request table 421c in the delivery request reception process is printed in the slip number print field D14.

FIG. 15B is a diagram illustrating another example of the delivery slip D1 according to the first embodiment. In detail, FIG. 15B illustrates the delivery slip D1 generated when the user information of the specific user includes the evacuation point information and the evacuation point disclosure permission information indicates disclosure approval. As illustrated in FIG. 15B, the evacuation point information registered to the package recipient table 421a is printed in the destination information print field D11 instead of the address information of the package recipient. Note that because images printed in the origin information print field D12 and the package information print field D13 are the same as those in the delivery slip D1 illustrated in FIG. 15A, description thereof is omitted.

Next, the delivery information registration process will be described with reference to FIGS. 2, 4, and 16. The delivery information registration process is executed by the delivery company terminal 3.

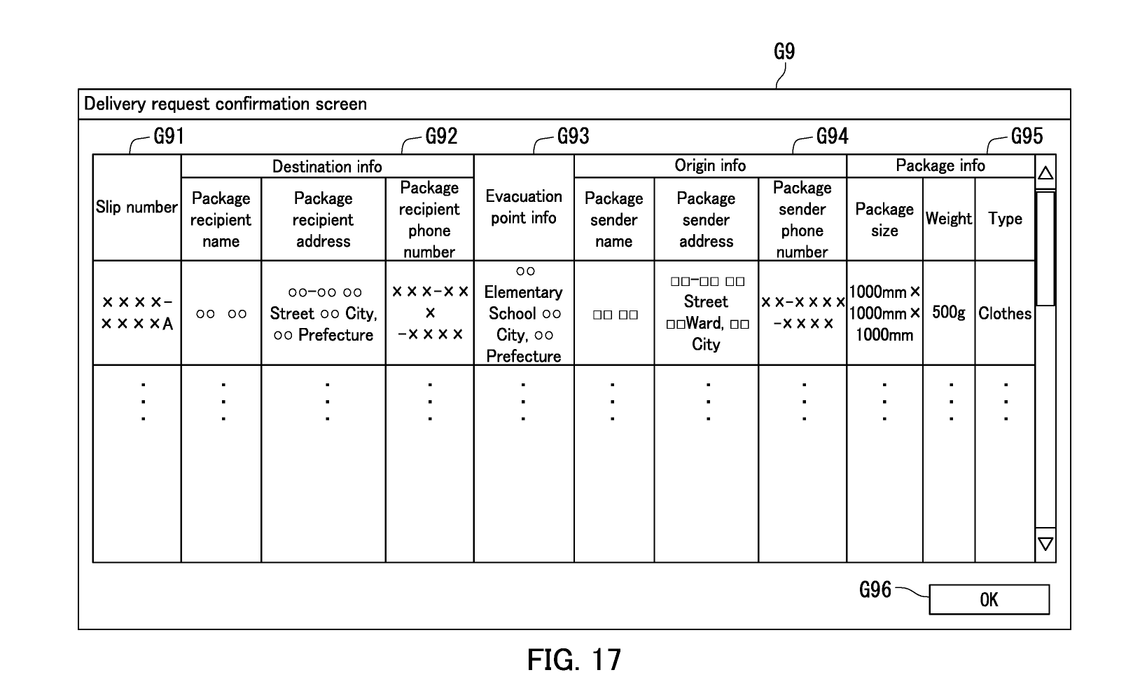

FIG. 16 is a diagram illustrating an example of a delivery information registration screen G8. The delivery information registration screen G8 is displayed on the third display 32 when the delivery information registration process is started.

As illustrated in FIG. 16, the delivery information registration screen G8 includes a region name information input field G81, a delivery possibility information input field G82, a delivery condition information input field G83, delivery possibility time information input field G84, an OK button G85, and a cancel button G86.

The region name information is inputted to the region name information input field G81. The delivery possibility information is inputted to the delivery possibility information input field G82. The delivery condition information is inputted to the delivery condition information input field G83. The delivery possibility time information is inputted to the delivery possibility time information input field G84.

When the OK button G85 is pressed, the third controller 35 registers the inputted region name information, the inputted delivery possibility information, the inputted delivery condition information, and the inputted delivery possibility time information to the delivery information table 421b, and ends the delivery information registration process. Note that the third controller 35 also ends the delivery information registration process when the cancel button G86 is pressed.

Continuing, the delivery request confirmation process will be described with reference to FIGS. 2, 3, 5, and 17. The delivery request confirmation process is executed by the delivery company terminal 3.

FIG. 17 is a diagram illustrating an example of a delivery request confirmation screen G9. The delivery request confirmation screen G9 is displayed on the third display 32 when the delivery request confirmation process is started and the third controller 35 acquires information from the database 421. According to the present embodiment, the third controller 35 acquires the delivery request information from the delivery request table 421c. Furthermore, the third controller 35 refers to the package recipient table 421a when acquiring the delivery request information. In detail, the third controller 35 acquires the evacuation point information of the package recipient from the package recipient table 421a when the evacuation point information of the package recipient included in the delivery request information is registered in the package recipient table 421a.

As illustrated in FIG. 17, the delivery request confirmation screen G9 includes a slip number display field G91, a destination information display field G92, an evacuation point information display field G93, an origin information display field G94, a package information display field G95, and an OK button G96. The delivery request confirmation screen G9 displays the information acquired from the delivery request table 421c. Furthermore, the delivery request confirmation screen G9 displays the evacuation point information acquired from the package recipient table 421a.

The delivery request confirmation process ends when the OK button G96 is pressed. The delivery company can deliver a package to the package recipient by referring to the delivery request confirmation screen G9 even when the package recipient is taking refuge at an evacuation point.

The first embodiment of the present disclosure is described above with reference to FIGS. 1 to 17. According to the present embodiment, a package sender can request delivery of a package upon confirming the safety of a package recipient.

Also according to the present embodiment, the package recipient can select whether or not to disclose information about an evacuation point. As such, privacy of the package recipient is protected.

Additionally, according to the present embodiment, a delivery company can provide delivery information concerning a disaster-affected region to the package sender. Therefore, the package sender can adjust the size and weight of the package to be sent to the disaster-affected region. As a result, delivery to the disaster-affected region can proceed without trouble.

Furthermore, according to the present embodiment, the safety information display screen G5 displays supply shortage information. Therefore, the package sender can know what supplies are needed in the disaster-affected region and give useful assistance.

Note that the present embodiment is described using an example in which the printer 13 is an electrographic printer. However, the printer 13 may be an inkjet or dot impact printer, for example.

Furthermore, the present embodiment is described using an example in which the image forming apparatus 1 is a multifunction peripheral. However, the image forming apparatus 1 is not limited to a multifunction peripheral. The image forming apparatus 1 may be a printer, for example.

The present embodiment is also described using an example in which an image exhibiting a delivery slip layout is formed in advance on a sheet (delivery slip sheet). Images exhibiting destination information, origin information, and package information are printed on the delivery slip sheet to generate the delivery slip. However, an image exhibiting the delivery slip layout and images exhibiting the destination information, the origin information, and the package information may be printed on an unprinted blank sheet to generate the delivery slip.

The present embodiment is described using an example in which the feeder 14 feeds sheets from a cassette. However, the feeder 14 may feed sheets placed on a manual feed table.

The present embodiment is described using an example in which specific information is registered to a package recipient table 421a before safety information is registered to the package recipient table 421a. However, the specific information may be registered in the safety information registration screen G3 together with the safety information. In such a case, the safety information registration screen G3 includes a name information input field and an address information input field instead of the name information display field G31 and the address information display field G32.

Also, the present embodiment is described using an example in which there is one delivery company. However, there may be multiple delivery companies. In such a case, the delivery system 5 includes a plurality of delivery company terminals 3, and delivery information is stored for each delivery company in the data management device 4. As such, the delivery information for each delivery company is provided to the package sender. As a result, the package sender can select from a plurality of delivery companies from which to request delivery by referring to the delivery information of each delivery company.

Furthermore, the present embodiment is described using an example in which the specific information includes name information and address information of the package recipient. However, the specific information may also include telephone number information of the package recipient, for example.

Also according to the present embodiment, the safety information registration screen G3 may further include a supply surplus information input field, for example. Information indicating a surplus of supplies at the evacuation point can be inputted to the surplus supply information input field. Therefore, the package sender can know what supplies are in surplus in the disaster-affected region and give useful assistance.

Furthermore, according to the present embodiment, delivery slip sheets of a certain size are fed when user information of a specific user does not include evacuation point information. Sheets of a different size are fed when the user information does include the evacuation point information. However, sheets of a different color may be fed, for example. Also, colors of the delivery slip layouts may be different.

In addition, the present embodiment is described using an example in which the delivery information includes the delivery condition information and the delivery possibility time information. However, the delivery information may only include one of the delivery condition information or the delivery possibility time information.

### Second Embodiment

Next, a second embodiment of the present disclosure will be described with reference to FIGS. 3, 7, 8, 18, and 19. The second embodiment differs from the first embodiment in that inputter information of a person who inputs safety information (an information inputter) is acquired in the safety information registration process. In the following, elements of the second embodiment that are different from the first embodiment will be described and a description of elements that are shared with the first embodiment will be omitted.

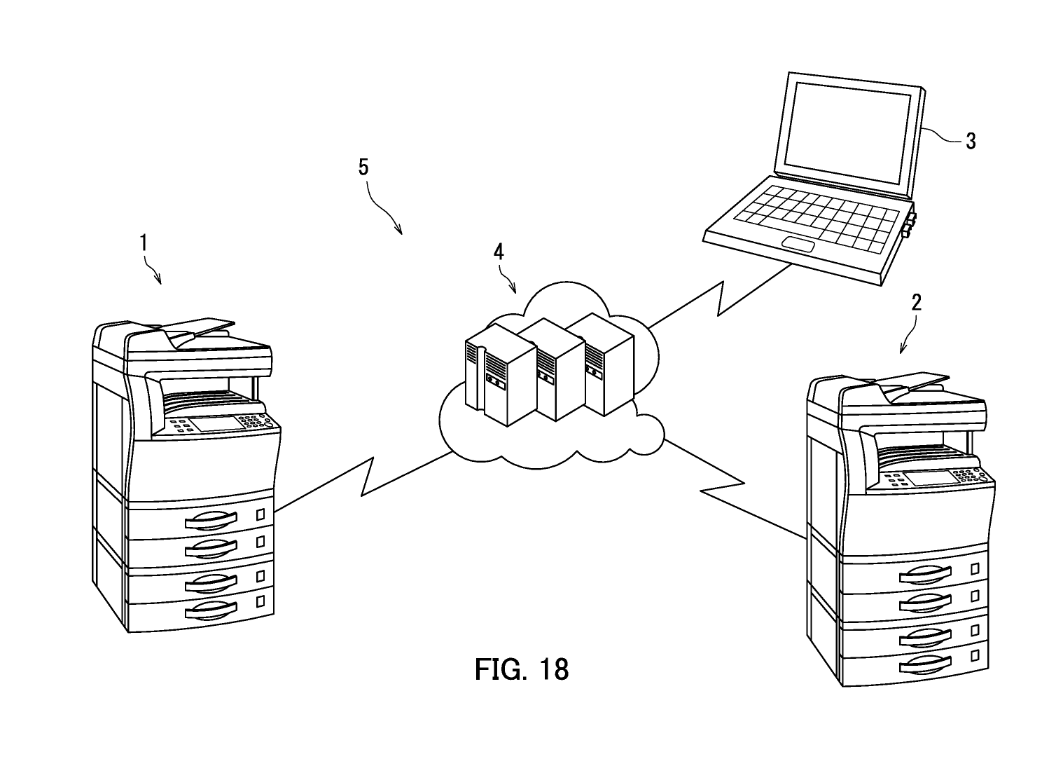

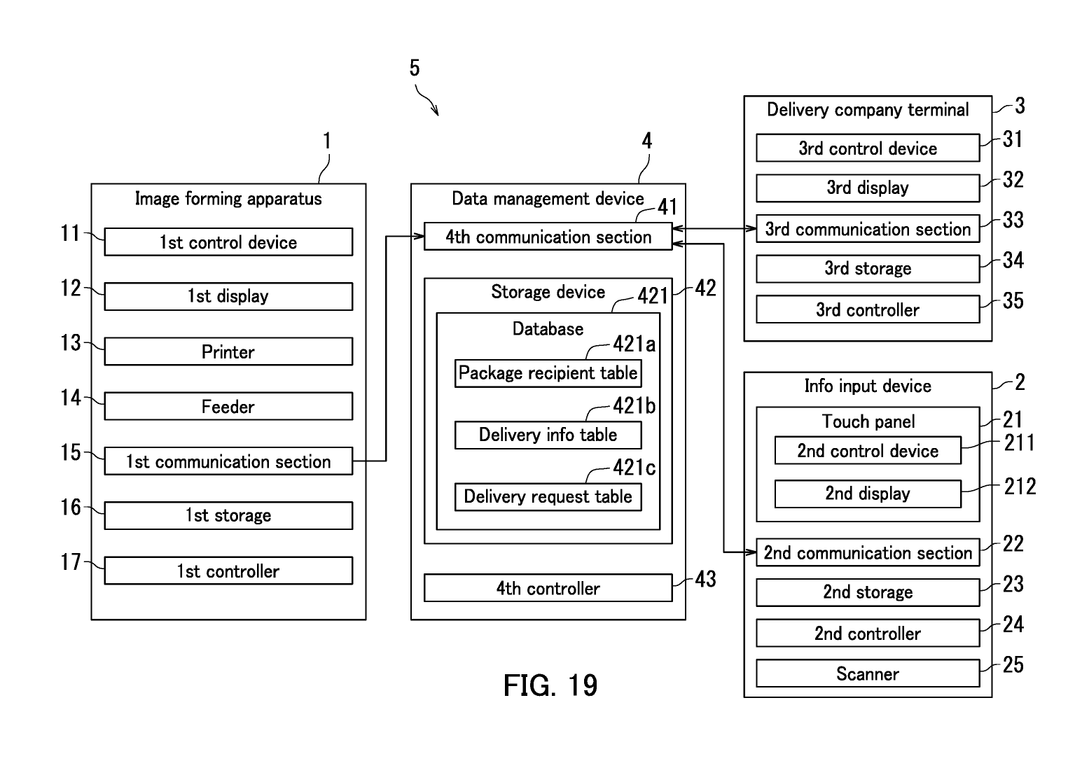

FIG. 18 is a diagram illustrating a configuration of a delivery system 5 according to the second embodiment. According to the present embodiment as illustrated in FIG. 18, an information input device 2 is a multifunction peripheral, for example. The information input device 2 is located in a place such as an evacuation shelter. FIG. 19 is a block diagram illustrating the configuration of the delivery system 5 according to the second embodiment. As illustrated in FIG. 19, the information input device 2 further includes a scanner 25. The scanner 25 is an example of an inputter information acquisition section.

The scanner 25 includes an original table and a reading mechanism. The reading mechanism reads an image of an original document placed on the original table to generate image data of the original document. The image data of the original document is sent to a second controller 24. According to the present embodiment, the original document is an identification document such as a driver's license.

The second controller 24 acquires the inputter information when receiving the image data of the original document sent from the scanner 25. In detail, the second controller 24 acquires the inputter information from an image exhibiting the inputter information included in the original document using an optical character recognition (OCR) function, for example. According to the present embodiment, the inputter information includes name information and address information.

After an OK button G23 is pressed on the user information retrieval screen G2 described with reference to FIG. 7, the second controller 24, for example, requires the identification document to be presented before displaying the safety information registration screen G3 described with reference to FIG. 8 on the touch panel 21. For example, the second controller 24 displays a message on the touch panel 21 prompting the information inputter to scan the identification document. Note that the timing in which the identification document is required to be presented is not limited hereto.

The second controller 24 determines the evacuation point disclosure permission information to be registered in the package recipient table 421a according to whether or not the identification document has been presented. In detail, the second controller 24 determines whether or not the image data of the original document (the inputter information of the information inputter) has been received from the scanner 25 within a predetermined amount of time since the identification document was requested to be presented. The second controller 24 registers the evacuation point disclosure permission information indicating disclosure refusal in the package recipient table 421a when determining that the image data of the original document was not received within the predetermined amount of time.

By contrast, the second controller 24 performs authentication (identity verification) of the information inputter when receiving the image data of the original document within the predetermined amount of time. The second controller 24 determines the evacuation point disclosure permission information to be registered in the package recipient table 421a according to an authentication result of the information inputter. Specifically, the second controller 24 determines whether or not the acquired inputter information (name information and address information) matches the specific information (name information and address information) inputted to the user information retrieval screen G2.

The second controller 24 registers the evacuation point disclosure permission information indicating disclosure refusal in the package recipient table 421a when determining that the inputter information does not match the specific information. The second controller 24 registers the evacuation point disclosure permission information inputted to the evacuation point disclosure permission information input field G35 of the safety information registration screen G3 to the package recipient table 421a when determining that the inputter information matches the specific information.

The second embodiment is described above. According to the present embodiment, authentication of the information inputter can be performed in the safety information registration process. Therefore, it is possible to prevent information about an evacuation point from being disclosed against the wishes of the package recipient.

Embodiments of the present disclosure are described above with reference to the drawings (FIGS. 1 to 19). However, the present disclosure is not limited to the above-described embodiments and can be practiced in various ways within the scope without departing from the essence of the present disclosure.

For example, the present embodiment is described using an example in which the data management device 4 includes the fourth controller 43. However, the data management device 4 need not include the fourth controller 43. In such a case, the first controller 17, the second controller 24, and the third controller 35 control operation of the data management device 4.

Also, the present disclosure is applicable to a configuration in which any of the following include a data management device: the image forming apparatus 1, the information input device 2, or the delivery company terminal 3.

What is claimed is:

1. A delivery system for assisting in delivery of a package to a package recipient, the package being sent at a request of a package sender, the delivery system comprising:
an information input device configured to receive input of specific information to specify the package recipient and safety information of the package recipient;
a data management device connected to the information input device and configured to communicate data therebetween and store the specific information and the safety information inputted to the information input device in association with each other; and
an image forming apparatus connected to the data management device and configured to communicate data therebetween, wherein
the image forming apparatus comprises:
a control device configured to receive an operation by the package sender;
a display configured to display a process result according to the operation received by the control device; and
a controller configured to control operation of the control device and the display, and
when the control device receives input of the specific information, the controller acquires the safety information associated with the inputted specific information from the data management device and displays the acquired safety information on the display.

2. The delivery system according to claim 1, further comprising:
a delivery company terminal connected to the data management device and configured to communicate data therebetween, wherein
the information input device further receives input of evacuation point information indicating an evacuation point of the package recipient,
the data management device stores the evacuation point information and the specific information in association with each other, and
the delivery company terminal displays the evacuation point information stored in the data management device.

3. The delivery system according to claim 2, wherein
the image forming apparatus further comprises a printer configured to print an image exhibiting destination information of the package on a sheet,
the information input device further receives input of disclosure permission information indicating either disclosure approval or disclosure refusal of the evacuation point information,
the data management device stores the disclosure permission information and the specific information in association with each other,
the destination information includes address information of the package recipient, and
the controller
directs the printer to print an image exhibiting the address information on the sheet when the disclosure permission information indicates the disclosure refusal, and
directs the printer to print an image exhibiting the evacuation point information instead of the address information on the sheet when the disclosure permission information indicates the disclosure approval.

4. The delivery system according to claim 3, wherein
the information input device comprises:
an inputter information acquisition section configured to acquire inputter information recorded on an identification document of an information inputter who inputs the safety information; and
an input controller configured to determine whether or not the inputter information acquisition section has acquired the inputter information, wherein
the input controller
stores the disclosure permission information indicating the disclosure refusal in the data management device when determining that the inputter information acquisition section has not acquired the inputter information.

5. The delivery system according to claim 4, wherein
the input controller
determines whether or not the inputter information matches the specific information when the inputter information acquisition section has acquired the inputter information,
stores the disclosure permission information indicating the disclosure refusal in the data management device when determining that the inputter information does not match the specific information,
prompts the information inputter to select either the disclosure approval or the disclosure refusal when determining that the inputter information matches the specific information, and
stores the disclosure permission information indicating the selected disclosure approval or the selected disclosure refusal in the data management device.

6. The delivery system according to claim 3, wherein
the image forming apparatus further comprises a feeder configured to feed a sheet from sheets of different types,
the printer prints an image on the sheet fed from the feeder,
the controller changes a type of the sheet to be fed by the feeder when the specific information received by the control device is in association with the evacuation point information.

7. The delivery system according to claim 3 wherein,
the controller directs the printer to print, on the sheet, an image notifying that the package needs to be delivered to the evacuation point when the specific information received by the control device is in association with the evacuation point information.

8. The delivery system according to claim 2, wherein
the delivery company terminal receives input of delivery information,
the delivery information indicates whether or not delivery to the evacuation point is possible,
the data management device stores the delivery information in association with the evacuation point information, and
the controller displays the delivery information on the display.

9. The delivery system according to claim 8, wherein
the delivery information includes at least one of information indicating a delivery condition and information indicating a time in which the delivery to the evacuation point is possible.

10. The delivery system according to claim 1, wherein
the data management device deletes the safety information when a period since a last update of the safety information exceeds a predetermined period.
